(19) United States
(12) Patent Application Publication
(10) Pub. No.: US 2013/0149789 A1
(43) Pub. Date: Jun. 13, 2013

(54) LIQUID TESTING SYSTEM

(71) Applicants: Ging-Ho Hsiue, Taoyuan County (TW); Shia-Chung Chen, Taoyuan County (TW); Yaw-Jen Chang, Taoyuan County (TW); Yi-Hua Fan, Taoyuan County (TW); Wen-Tyng Li, Taoyuan County (TW); Yung Chang, Taoyuan County (TW); Ming-Fa Hsieh, Taoyuan County (TW); Ching-Wei Huang, Taoyuan County (TW); Ying-Ming Liang, Taoyuan County (TW)

(72) Inventors: Ging-Ho Hsiue, Taoyuan County (TW); Shia-Chung Chen, Taoyuan County (TW); Yaw-Jen Chang, Taoyuan County (TW); Yi-Hua Fan, Taoyuan County (TW); Wen-Tyng Li, Taoyuan County (TW); Yung Chang, Taoyuan County (TW); Ming-Fa Hsieh, Taoyuan County (TW); Ching-Wei Huang, Taoyuan County (TW); Ying-Ming Liang, Taoyuan County (TW)

(21) Appl. No.: 13/490,171

(22) Filed: Jun. 6, 2012

(30) Foreign Application Priority Data
Dec. 7, 2011 (TW) 100145013

(51) Int. Cl. G01N 21/75

(52) U.S. Cl. 436/164; 422/82.05

(57) ABSTRACT

A liquid testing system is provided, which includes a distribution module, a testing chip, a driving module and an image analyzing module. The distribution module is for providing a liquid. The testing chip receives the liquid from the distribution module. The driving module is connected to the testing chip and drives the testing chip to rotate, wherein the liquid flowing in the testing chip is actuated by centrifugal force. The image analyzing module produces and analyzes an image of the liquid in the testing chip.

### CROSS REFERENCE TO RELATED APPLICATIONS

This Application claims priority of Taiwan Patent Application No.100145013, filed on Dec. 7, 2011, the entirety of which is incorporated by reference herein.

### BACKGROUND OF THE INVENTION

1. Technical Field

The invention relates to a liquid testing system, and more particularly, the invention relates to a liquid testing system in which liquid is driven by centrifugal force.

2. Description of the Related Art

In medical procedures, testing of a particular liquid sample is often executed, and test results are used as factors for clinical judgments. Take blood infusion as an example, blood typing must be carried out before blood infusion. The microplate method, one of the available blood typing methods, is generally carried out in a 96-well microtiter plate by manual operation. It is tedious and laborious. Thus, an automatic blood testing system is desired.

In the past decade, the development of bioMEMS (Biomedical mircoelectro-mechanical system) has evoked strong interest in the fields of medical research, biochemical analysis, and clinical diagnosis, wherein microfluidic devices are primary components of most bioMEMS devices. While testing, reagents and samples can be transported in the microchannels for dilution, particle separation, mixing and incubation.

In the dissertation “disposable integrated microfluidic biochip for blood typing by plastic microinjection molding” issued by Kim et al., a low cost disposable microfluidic biochip for blood typing is presented. In the dissertation “replication quality of flow-through microfilters in cicorfluidic lab-on-a-chip for blood typing by microinjection molding” issued by Lee et al., a flow-through micofilter in a microfluidic lab-on-a-chip to filter out agglutinated RBCs in blood typing is presented.

The centrifugal microfluidic platform is another bioMEMS technique which is widely adopted for the development of polymerase chain reaction (PCR) device and ELISA system in recent years.

### BRIEF SUMMARY OF THE INVENTION

To overcome drawbacks in conventional liquid testing processes, one of the objectives of the invention is to provide a liquid testing system with higher testing efficiency. The other objective of the invention is to provide a liquid testing method which facilitates automatic liquid testing processes.

To achieve the above objectives, the invention provides a liquid testing system, which includes a distribution module, a testing chip, a driving module and an image analyzing module. The distribution module is for providing a liquid. The testing chip receives the liquid from the distribution module. The driving module is connected to the testing chip and drives the testing chip to rotate, wherein the liquid flowing in the testing chip is actuated by centrifugal force. The image analyzing module produces and analyzes an image of the liquid in the testing chip.

In the above embodiment, the driving module includes a rotation device and a lifting device. The rotation device is connected to the testing chip to drive the testing chip to rotate. The lifting device is connected to the rotation device and provides a force to allow the testing chip to have a displacement in a vertical direction.

In the above embodiment, the distribution module includes a moving device and a burette disposed on the moving device. When the burette is moved by the moving device to a place corresponding to the testing chip, the liquid is provided from the burette to the testing chip. The image analyzing module includes a capturing device and a determination device, the image of the fluid in the testing chip is produced by the capturing device, and the image is received and analyzed by the processing unit.

In the above embodiment, the liquid testing system further includes a heating device corresponding to the testing chip, and the heating device is for heating the liquid in the testing chip.

In the above embodiment, the liquid testing system further includes a mounted platform and a plurality of testing chips. The testing chips are disposed between a substantial center of the mounted platform and a rim of the mounted platform.

The invention also provides a liquid testing method which includes: injecting liquids into a plurality of sample chambers in a testing chip, and rotating the testing chip at a predetermined rotation speed; determining whether the predetermined rotation speed is greater than a rated rotation speed; opening at least one of the sample chambers to allow the liquids to flow into a reaction chamber; rotating the testing chip at a mixing rotation speed to carry out reaction of different liquids in the reaction chamber; and producing and analyzing an image of the liquids in the reaction chamber, wherein the mixing rotation speed is smaller than the rated rotation speed, and each of the sample chambers includes a liquid different from liquids in the other sample chambers.

In the above embodiment, the liquid testing method further includes rotating the testing chip at a draining rotation speed to drain off the reacted liquids.

Through the liquid testing system of the invention, the testing liquid may be injected into the sample chambers according to a predetermined dosage, and the sample chambers are closed or opened by centrifugal force caused by rotation of the testing chip; thus, the probability of human error may be reduced. In addition, the liquid testing time can be remarkably reduced due to an instant judgment by the determination device of the image analyzing module.

### BRIEF DESCRIPTION OF THE DRAWINGS

The embodiment can be more fully understood by reading the subsequent detailed description and examples with references made to the accompanying drawings, wherein:

FIG. 1 shows a schematic view of a liquid testing system of a preferred embodiment of the invention;

FIG. 2 shows a top schematic view of a mounted platform of the preferred embodiment of the invention;

FIG. 3 shows a cross-sectional schematic view of a lifting device of the preferred embodiment of the invention;

FIG. 4 shows a schematic view of partial elements of the lifting device of the preferred embodiment of the invention;

FIG. 5 shows a schematic view of the image analyzing system of the preferred embodiment of the invention; and

FIG. 6 shows a flowchart describing a liquid testing method of the preferred embodiment of the invention.

### DETAILED DESCRIPTION OF THE INVENTION

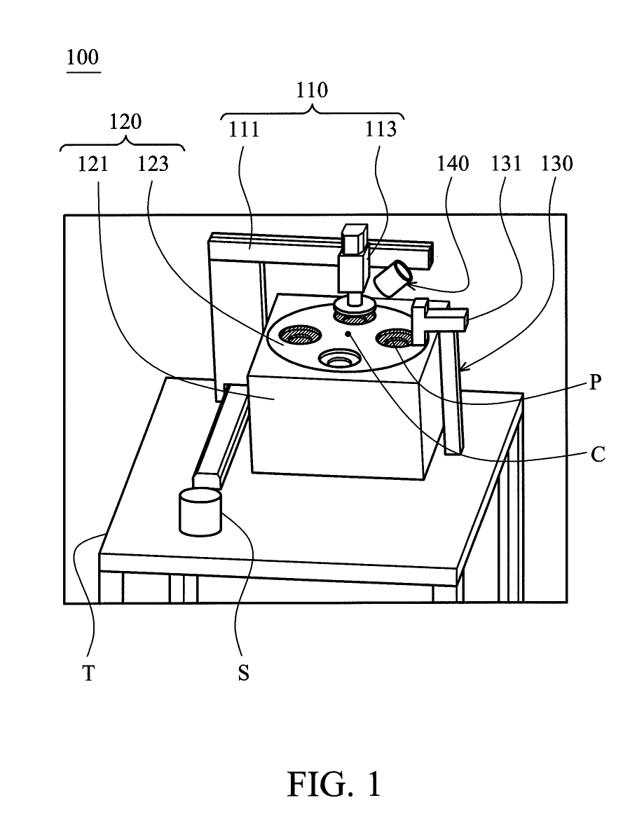

Please refer to FIG. 1, which shows a schematic view of a liquid testing system 100 of a preferred embodiment of the invention. The liquid testing system 100 includes a distribution module 110, an apparatus 120, a plurality of testing chips P, an image analyzing module 130 and a heating module 140.

In the embodiment, the liquid testing system 100 may be placed on a table T for blood typing. Reagents which are going to have reactions with the blood fluid are disposed in the sample box S on the table T. The distribution module 110 includes a robot arm 111 and a burette 113. The robot arm 111 includes a three-axis linear sliding rail, and the motion of the burette 113 along the three perpendicular axes is controlled by an axis motion controller. The reagents from the sample box S are attracted into the burette 113 due to a common pump operating principle, and the injection pressure is adjusted by a spring (not shown in the figure) which is disposed in the burette 113, such that the dosage of the reagents and related medical waste may be decreased. The heating module 140 corresponds to the testing chip P, and the liquid in the testing chip P is heated by the heating module 140. In one exemplary embodiment, heated air is produced by the heating module 140, and the testing chip P is heated to 37° C.

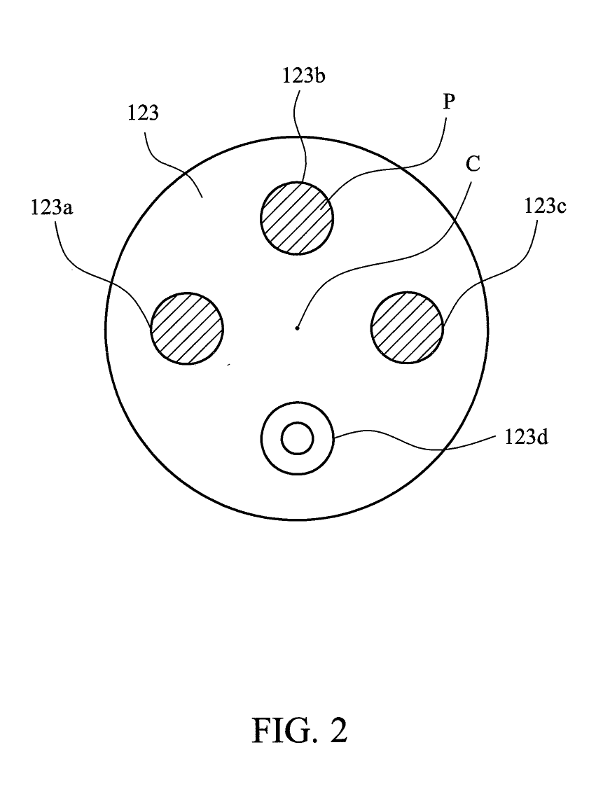

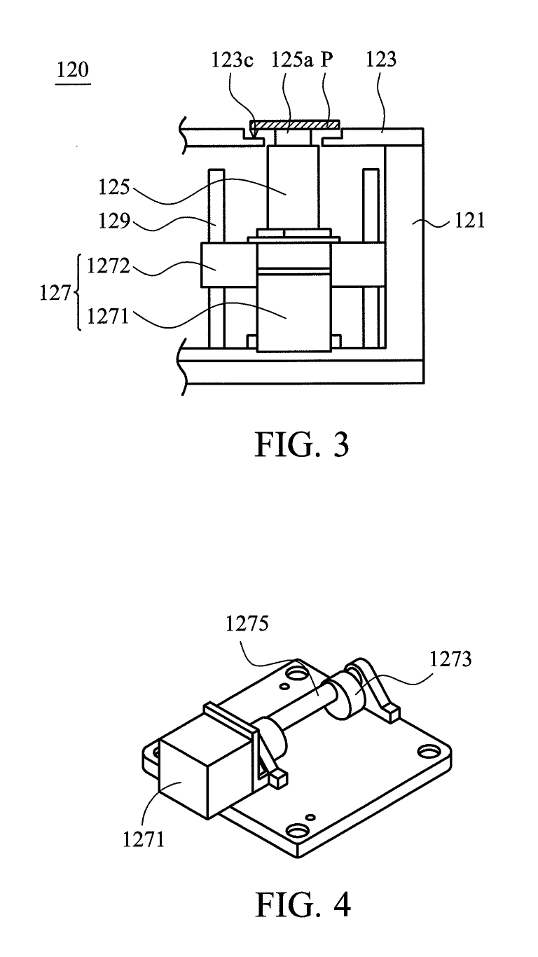

Please refer to FIGS. 2 and 3. FIG. 2 shows a top schematic view of a mounted platform 123 of the preferred embodiment of the invention, and FIG. 3 shows a cross-sectional schematic view of a lifting device 127. The apparatus 120 includes a main body 121, a mounted platform 123, a rotation device 125, a lifting device 127 and a plurality of sliding rails 129.

The mounted platform 123 is rotatably disposed on the main body 121. The mounted platform 123 includes a plurality of accommodating spaces 123a, 123b, 123c and 123d, disposed between a substantial center of the mounted platform 123 and a rim of the mounted platform 123, wherein the testing chip P is optionally disposed thereon.

In one exemplary embodiment, blood fluid for blood typing is manually injected into the testing chip P placed on the accommodating space 123a; the reagents which are going to have reactions with the blood fluid is injected into the testing chip P placed on the accommodating space 123b by the burette 113 (FIG. 1); the reacted liquid in the testing chip P placed on the accommodating space 123c is observed by the image analyzing module 130 (FIG. 1) corresponding thereto; used and polluted testing chip P or new testing chip P is unloaded/loaded at the accommodating space 123d. The mounted platform 123 rotates clockwise after the completion of the above processes, and, again, different processes are performed at respective testing chips P in different accommodating spaces 123a, 123b, 123c and 123d.

Please refer to FIGS. 3 and 4. FIG. 4 shows a schematic view of partial elements of the lifting device 127 of the preferred embodiment of the invention. The rotation device 125 is disposed on the sliding rails 129 and moves upward along the sliding rails 129 when the testing chip P is located upon the rotation device 125, such that the rotation head 125a of the rotation device 125 is connected to the testing chip P to drive the testing chip P to rotate. It is noted that during the rotation of the testing chip P, liquid in the testing chip P is driven by centrifugal force to flow therein. Additionally, each of the testing chips P may further includes a plurality of sample chambers (not shown in figures) disposed therein, and different or the same reagent is added into each of the sample chambers, wherein each of the sample chambers has an obstruction member, such as a capillary valve (not shown in figures), and the obstruction members are closed or opened according to the rotation speed of the testing chip P.

The lifting device 127 includes a motor 1271, a sliding base 1272, a cam 1273 and a shaft 1275. The rotation device 125 is disposed on the sliding base 1272, and the sliding base 1272 is connected to the sliding rail 129 disposed in the main body 121. The shaft 1275 is actuated by the motor 1271 to drive the cam 1273 to rotate. When cam 1273 is rotated about the shaft 1275, the sliding base 1272 is abutted by the cam 1273, and the rotation device 125 disposed on the sliding base 1272 and the testing chip P disposed on the rotating device 125 simultaneously move upward in a vertical direction, thereby the rotation head 125a of the rotation device 125 is connected to the testing chip P.

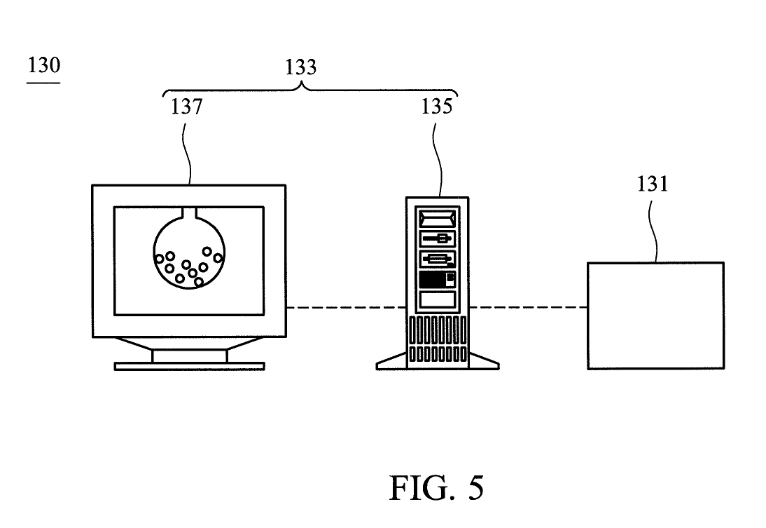

Please refer to FIG. 5, which shows a schematic view of the image analyzing system 130 of the preferred embodiment of the invention. The image analyzing system 130 includes a capturing device 131 and a determination device 133. The capturing device 131 is a CCD camera. After reaction of the blood fluid in the testing chip P is finished, an image of the reacted blood fluid in the fluid path is produced by the capturing device 131. In the embodiment, the determination device 133 includes a processing unit 135 and a display device 137, the image produced by the capturing device 131 is received and analyzed by the processing unit 135, and the analysis results from the processing unit 135 and the image produced by the capturing device 131 are shown at the display device 137.

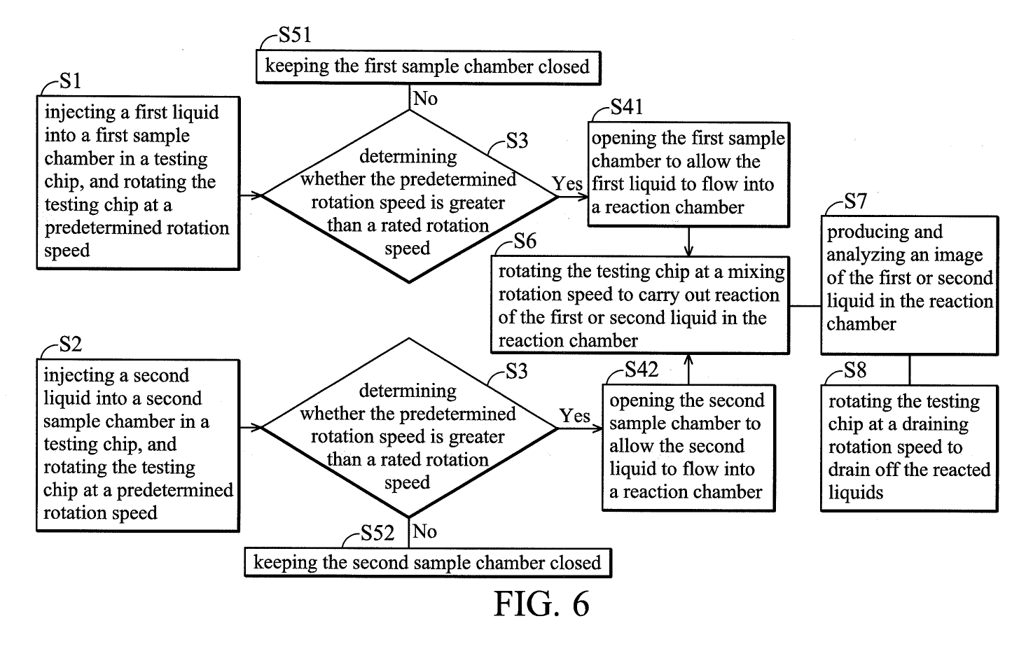

Referring to FIGS. 1 and 6, a flowchart describing a liquid testing method of the preferred embodiment of the invention is shown in FIG. 6. The liquid testing method is elaborated below: in the beginning of the liquid testing, the burette 113 is firstly moved to a place corresponding to the testing chip P by the robot arm 111 of the distribution module 110, and after the burette 113 is moved the burette 113 provides blood fluid or reagents into the testing chip P, and the testing chip P is rotated at a predetermined rotation speed (S1 and S2). At the same time, the obstruction members of each of the sample chambers on the testing chip P determine whether the predetermined rotation speed is greater than a rated rotation speed (S3). If the predetermined rotation speed is greater than the rated rotation speed, the obstruction members open, and the reagents are swung into a reaction chamber on the testing chip P (S41 and S42). On the contrary, if the predetermined rotation speed is greater than the rated rotation speed, the obstruction members keep closed (S51 and S52). After the liquid flows into the reaction chamber on the testing chip P, the testing chip P is rotated by a mixing rotation speed such that the reaction of the liquids is carried out in the reaction chamber (S6). Next, an image of the liquid in the reaction chamber is produced and analyzed by the image analyzing system 130, and the process of liquid testing is completed (S7).

If a second reaction is going to be carried out on the reaction chamber of the testing chip P, the testing chip P may be rotated at a draining rotating speed, and the reacted fluid is drained off from the reaction chamber of the testing chip P (S8). Next, another liquid is injected into the testing chip P, and the steps (S1-S7) are repeated.

The liquid testing method may be further understood with a detailed description given below. It is appreciated that the following description is not intended to limit the scope of the present invention, and those skilled in the art will recognize that the steps and the dosage of reagents can be changed according to demand.

For ABO blood typing, the testing method is as follows: 2 μL, of 3% red blood cell and 5 μL of antibodies of type A or type B (diluted to 1-512 times) are injected into sample chambers of the testing chip P. The testing chip P is rotated at 1400 rpm for 10 seconds to drive the fluid flowing into the reaction chamber by centrifugal force. Next, the testing chip P is rotated by clockwise-counterclockwise rotation six times and allowed to stand for one minute to observe the image of the coagulation of blood fluid.

For Rh blood typing, the testing method is as follows: 2 μL of 3% red blood cell, 5 μL of antibodies of type D or type E (diluted to 1-128 times), 5 μL of low ionic strength medium, 2 μL of hexadimethrine bromide solution, and 2 μL of resuspension solution are injected into sample chambers of the testing chip P. In the first step, the testing chip P is rotated at 1400 rpm for 10 seconds to drive the low ionic strength medium, the antibodies and the 3% red blood cell flowing into the reaction chamber by centrifugal force, and the testing chip P is rotated by clockwise-counterclockwise rotation at 350 rpm six times and allowed to stand for one minute. In the second step, the testing chip P is rotated at 1700 rpm for 10 seconds to drive the hexadimethrine bromide solution flowing into the reaction chamber by centrifugal force, and the testing chip P is rotated by clockwise-counterclockwise rotation at 350 rpm six times and allowed to stand for one minute. In the third step, the testing chip P is rotated at 1800 rpm for ten seconds to drain off the reacted ionic liquid. In the fourth step, the testing chip P is rotated at 2150 rpm for ten seconds to drive the resuspension solution flowing into the reaction chamber, and the testing chip P is rotated by clockwise-counterclockwise rotation twenty times to separate the red blood cells which have not been agglutinated. Last, an image of coagulation is observed after the testing chip P stands for one minute.

Through the liquid testing system and liquid testing method, the processing order and the processing time of each of the steps can be set in advance so as to increase liquid testing efficiency.

While the embodiment has been described by way of example and in terms of the embodiments, it is to be understood that the embodiment is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid testing system, comprising:
a distribution module for providing a liquid;
a testing chip, receiving the liquid from the distribution module;
a driving module, connected to the testing chip and driving the testing chip to rotate, wherein the liquid flowing in the testing chip is actuated by centrifugal force; and
an image analyzing module, producing and analyzing an image of the liquid in the testing chip.

2. The liquid testing system as claimed in claim 1, wherein the driving module comprises a rotation device, connected to the testing chip and driving the testing chip to rotate.

3. The liquid testing system as claimed in claim 2, wherein the driving module comprises a lifting device, connected to the rotation device and providing a force to allow the testing chip to have a displacement in a vertical direction.

4. The liquid testing system as claimed in claim 1, wherein the distribution module comprises a moving device and a burette disposed on the moving device, wherein, when the burette is moved by the moving device to a place corresponding to the testing chip, the liquid is provided from the burette to the testing chip.

5. The liquid testing system as claimed in claim 1, further comprising a heating device, corresponding to the testing chip, for heating the liquid in the testing chip.

6. The liquid testing system as claimed in claim 1, wherein the image analyzing module includes a capturing device and a determination device, the image of the fluid in the testing chip is produced by the capturing device, and the image is received and analyzed by the determination device.

7. The liquid testing system as claimed in claim 1, further comprising a mounted platform and a plurality of testing chips, wherein the testing chips are disposed between a substantial center of the mounted platform and a rim of the mounted platform.

8. A liquid testing method, comprising:
injecting liquids into a plurality of sample chambers in a testing chip, and rotating the testing chip at a predetermined rotation speed;
determining whether the predetermined rotation speed is greater than a rated rotation speed;
opening at least one of the sample chambers to allow the liquids to flow into a reaction chamber;
rotating the testing chip at a mixing rotation speed to carry out reaction of different liquids in the reaction chamber; and
producing and analyzing an image of the liquids in the reaction chamber.

9. The liquid testing method as claimed in claim 8, wherein the mixing rotation speed is less than the rated rotation speed.

10. The liquid testing method as claimed in claim 8, wherein each of the sample chambers comprises a liquid different from liquids in the other sample chambers.

11. The liquid testing method as claimed in claim 8, further comprising rotating the testing chip at a draining rotation speed to drain off the reacted liquids.
